(19) United States
(12) Patent Application Publication
(10) Pub. No.: US 2026/0286915 A1
(43) Pub. Date: Sep. 24, 2026

(54) CONTROL DEVICE, GAS ENGINE, CONTROL METHOD, AND PROGRAM

(71) Applicant: MITSUBISHI HEAVY INDUSTRIES ENGINE & TURBOCHARGER, LTD., Sagamihara-shi, Kanagawa (JP)

(72) Inventors: Shun KITAGAWA, Sagamihara-shi (JP); Masataka SHIRAISHI, Sagamihara-shi (JP); Yuta FURUKAWA, Sagamihara-shi (JP); Hiroshi ASO, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 19/168,408

(22) PCT Filed: Jan. 23, 2024
(86) PCT No.: PCT/JP2024/001866

§ 371 Date: Sep. 24, 2025

(30) Foreign Application Priority Data
Mar. 28, 2023 (JP) 2023-051798

(51) Int. Cl. F02D 41/38; F02D 41/00

(52) U.S. Cl. CPC F02D 41/3863; F02D 41/0027; F02D 2200/101

(57) ABSTRACT

Provided is a control method that suppresses a surge in rotation speed due to excess fuel when a load of a gas engine has abruptly dropped. This control device is for controlling a vent valve that is connected to the downstream side of a fuel control valve of a fuel supply line through which fuel is supplied to a gas engine and that is provided in an exhaust line for guiding the fuel to the outside of the fuel supply line, the control device comprising: a signal acquisition unit which acquires a signal indicating an abrupt drop in a load of the gas engine; and a control unit which opens the vent valve upon acquisition of said signal.

### TECHNICAL FIELD

The present disclosure relates to a control device, a gas engine, a control method, and a program. The present disclosure claims priority based on Japanese Patent Application No. 2023-51798 filed in Japan on Mar. 28, 2023, the contents of which are incorporated herein by reference.

### BACKGROUND ART

In the gas engine, all fuel gas that passes through the fuel control valve is introduced into a cylinder in the engine and is combusted to contribute as rotational energy. Therefore, in a case where the load of the engine is rapidly decreased, it is necessary to instantaneously throttle the fuel gas with the fuel control valve and prevent the rotation speed of the engine from excessive increase due to the surplus fuel gas. However, even when the fuel gas is instantaneously throttled by the fuel control valve, the fuel gas remaining in the pipe after passing through the fuel control valve is supplied to the cylinder in the engine and is combusted as a surplus fuel, which may cause an excessive increase in the rotation speed of the engine. At this time, when the rotation speed of the engine increases to a certain level or higher, there is a possibility that a serious failure stop may be caused by an alarm trip.

PTL 1 discloses control for improving the responsiveness of a gas engine during transient operation such as load application and load cutoff, but does not disclose means for solving the above-described problems.

### CITATION LIST

### Patent Literature

[PTL 1] Japanese Unexamined Patent Application Publication No. 2009-57872

### SUMMARY OF INVENTION

### Technical Problem

A technique for suppressing an excessive increase in the rotation speed of an engine when the load on a gas engine is rapidly decreased is required.

The present disclosure provides a control device, a gas engine, a control method, and a program capable of solving the above-described problems.

### Solution to Problem

According to one aspect of the present disclosure, there is provided a control device for a vent valve provided in an exhaust line that is connected to a downstream side of a fuel control valve in a fuel supply line that supplies a fuel to a gas engine, and guides the fuel to an outside of the fuel supply line, the control device including a signal acquisition unit that acquires a signal indicating a rapid decrease in a load of the gas engine, and a control unit that opens the vent valve when the signal is acquired.

According to one aspect of the present disclosure, there is provided a gas engine including a fuel supply line that supplies a fuel to the gas engine, a fuel control valve provided in the fuel supply line, an exhaust line having one end connected to a downstream side of the fuel control valve in the fuel supply line, a vent valve provided in the exhaust line, and the control device described above.

According to an aspect of the present disclosure, there is provided a control method for a vent valve provided in an exhaust line that is connected to a downstream side of a fuel control valve in a fuel supply line that supplies a fuel to a gas engine, and guides the fuel to an outside of the fuel supply line, the control method including a step of acquiring a signal indicating a rapid decrease in a load of the gas engine, and a step of opening the vent valve when the signal is acquired.

According to an aspect of the present disclosure, there is provided a program causing a computer to execute a step of acquiring a signal indicating a rapid decrease in a load of a gas engine, and a step of opening a vent valve provided in an exhaust line that is connected to a downstream side of a fuel control valve in a fuel supply line that supplies a fuel to a gas engine, and guides the fuel to an outside of the fuel supply line, when the signal is acquired.

### Advantageous Effects of Invention

According to the control device, the gas engine, the control method, and the program described above, it is possible to suppress an excessive increase in the rotation speed of the engine when the load on the gas engine is rapidly decreased.

### BRIEF DESCRIPTION OF DRAWINGS

FIG. 1 is a schematic diagram of a main part of a gas engine according to an embodiment.

FIG. 2 is a flowchart showing an example of opening and closing control of a vent valve according to the embodiment.

FIG. 3 is a diagram showing the effect of the opening and closing control of the vent valve according to the embodiment.

FIG. 4A is a first diagram showing another example of a connection destination of the exhaust line according to the embodiment.

FIG. 4B is a second diagram showing another example of a connection destination of the exhaust line according to the embodiment.

FIG. 5 is a schematic diagram showing an example of a hardware configuration of the control device according to the embodiment.

### DESCRIPTION OF EMBODIMENTS

### Embodiment

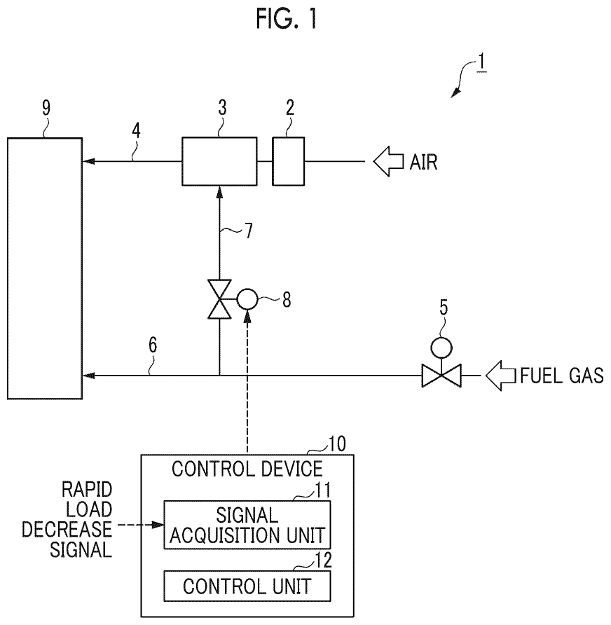

Hereinafter, a configuration of a gas engine 1 of the present disclosure and control thereof will be described with reference to FIGS. 1 to 5.

FIG. 1 schematically shows a portion of the gas engine 1 related to the present embodiment. The gas engine 1 includes an air cleaner 2, an air cleaner box 3, an air supply line 4, a fuel control valve 5, a fuel supply line 6, an exhaust line 7, a vent valve 8, an engine 9, and a control device 10. The air supply line 4, the fuel supply line 6, and the exhaust line 7 are formed of pipes. The air supply line 4 that supplies air is connected to the engine 9 and supplies air to a cylinder in the engine 9. The air supply line 4 is provided with an air cleaner 2 that removes dust and foreign matter in the intake air and an air cleaner box 3. The fuel supply line 6 that supplies the fuel is connected to the engine 9 and supplies the fuel gas to the auxiliary chamber in the engine 9. The engine 9 is, for example, a reciprocating engine, and rotationally drives a generator (not shown) by combusting the supplied air and fuel gas. The fuel supply line 6 is provided with a fuel control valve 5 for controlling the supply amount of the fuel gas. One end of the exhaust line 7 is connected to a downstream side of the fuel control valve 5 in the fuel flow direction in the fuel supply line 6, and the other end of the exhaust line 7 is connected to the air cleaner box 3. A vent valve 8 is provided in the exhaust line 7. At normal times, the vent valve 8 is closed, and by opening the vent valve 8, the fuel gas flowing through the fuel supply line 6 can be guided to the air cleaner box 3 through the exhaust line 7. One end of the exhaust line 7 is connected to a position closer to the engine 9 than the fuel control valve 5 in the fuel supply line 6. For example, when the length of the fuel supply line 6 from the fuel control valve 5 to the engine 9 is several meters (2 to 3 m), one end of the exhaust line 7 is connected to a position of 1 m or less from the engine 9. This is for effectively discharging the fuel gas (fuel gas remaining in the pipe after passing through the fuel control valve 5) remaining on the downstream side of the fuel control valve 5 when the load rapidly decreases.

In the related art, the gas engine is not provided with the exhaust line 7 and the vent valve 8. In this case, when the load of the gas engine is rapidly decreased, even if the fuel control valve 5 is throttled according to the load, the fuel gas that is already present in the pipe on the downstream side of the fuel control valve 5 is supplied to the cylinder in the engine as it is, and there is a possibility that the rotation speed of the engine may increase excessively. In order to prevent this, in the present embodiment, the exhaust line 7 and the vent valve 8 are provided, and when the load of the gas engine 1 is rapidly decreased, the vent valve 8 is opened, and the surplus fuel gas present on the downstream side of the fuel control valve 5 is released to the outside of the fuel supply line 6. In this manner, the amount of fuel gas supplied to the engine 9 is reduced at the time of a rapid decrease in load, and an excessive increase in the rotation speed of the engine 9 is suppressed. The fuel gas guided to the air cleaner box 3 through the exhaust line 7 is mixed with a large amount of air and is supplied to the engine 9. However, the amount of the fuel gas is very small compared to the air, and the influence on the increase in the rotation speed can be ignored. By guiding the fuel gas to the air cleaner box 3, the fuel gas is not released around the engine 9 or the generator (not shown), so that safety can be ensured, and the fuel gas is supplied to the engine 9 through the air supply line 4 together with a large amount of air, so that fuel consumption can be improved.

The control device 10 controls opening and closing of the vent valve 8. The control device 10 includes a signal acquisition unit 11 and a control unit 12.

The signal acquisition unit 11 acquires a rapid load decrease signal indicating a rapid decrease in the load of the gas engine 1. In addition to the rapid load decrease signal, the signal acquisition unit 11 may acquire a load signal indicating the magnitude of the load of the gas engine 1 from time to time and a rotation speed signal indicating the rotation speed of the engine 9 from time to time. These signals are transmitted from a higher-level control device (not shown), a sensor that detects the rotation speed, or the like. For example, when the load of the gas engine 1 decreases by a predetermined value or more within a certain time, a higher-level control device (not shown) generates a rapid load decrease signal and outputs the rapid load decrease signal to the control device 10. When the rapid decrease in the load ends, the higher-level control device (not shown) stops the output of the rapid load decrease signal. For example, a higher-level control device (not shown) outputs a load signal or a rotation speed signal to the control device 10 at a predetermined control cycle. The signal acquisition unit 11 acquires these signals and outputs the acquired signals to the control unit 12.

The control unit 12 controls opening and closing of the vent valve 8. For example, when the signal acquisition unit 11 acquires the rapid load decrease signal, the control unit 12 opens the vent valve 8. Thereafter, when the signal acquisition unit 11 stops acquiring the rapid load decrease signal, the control unit 12 closes the vent valve 8. Alternatively, when the load of the gas engine 1 indicated by the load signal acquired by the signal acquisition unit 11 is stable (the magnitude of the load falls within a predetermined range) after the load rapidly decreases, the control unit 12 may close the vent valve 8. When the rotation speed of the engine 9 indicated by the rotation speed signal acquired by the signal acquisition unit 11 increases after the load rapidly decreases and then starts to decrease, the control unit 12 may close the vent valve 8. The opening degree of the fuel control valve 5 is controlled by a higher-level control device (not shown) according to the load of the gas engine 1. For example, at the time of a rapid decrease in load, the opening degree of the fuel control valve 5 is instantaneously throttled to a predetermined opening degree.

### Operation

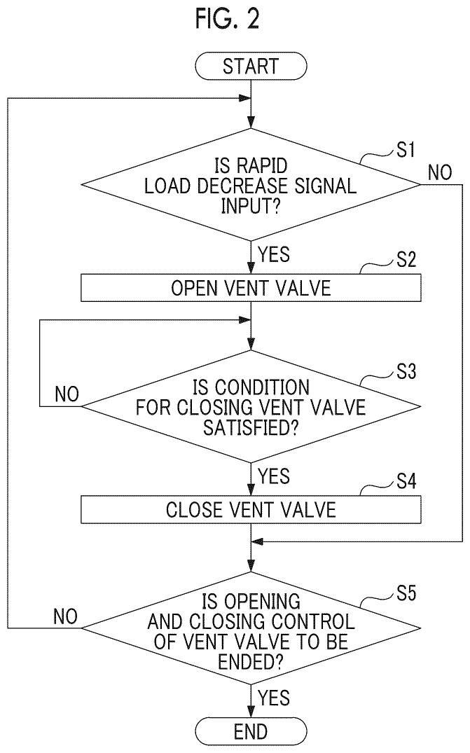

Next, the control of the vent valve 8 will be described with reference to FIG. 2.

FIG. 2 is a flowchart showing an example of vent valve control according to the embodiment.

The vent valve 8 is closed during normal operation. The control unit 12 determines whether the rapid load decrease signal has been input (step S1). While the signal acquisition unit 11 does not acquire the rapid load decrease signal, the control unit 12 determines that the rapid load decrease signal is not input (step S1: No), and the process proceeds to step S5.

When the signal acquisition unit 11 acquires the rapid load decrease signal, the control unit 12 determines that the rapid load decrease signal has been input (step S1: Yes), and opens the vent valve 8 (step S2). In this manner, a portion of the surplus fuel gas remaining in the fuel supply line 6 after passing through the fuel control valve 5 is discharged to the air cleaner box 3 through the exhaust line 7, and the amount of the fuel gas supplied to the engine 9 can be reduced as compared with the related art.

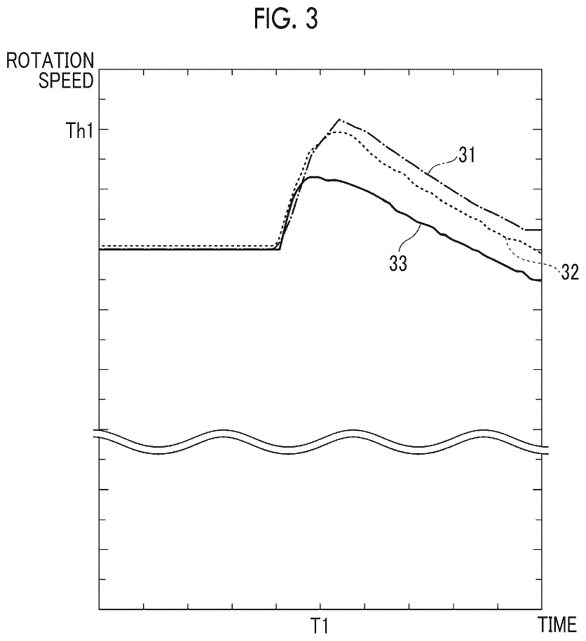

When the vent valve 8 is opened, the control unit 12 then determines whether a condition for closing the vent valve 8 is satisfied (step S3). Examples of the condition for closing the vent valve 8 include the following.
(1) The input of the rapid load decrease signal is not received. The control unit 12 determines that the condition for closing the vent valve 8 is satisfied when the signal acquisition unit 11 stops acquiring the rapid load decrease signal.
(2) The rapidly decreased load is stabilized. The control unit 12 determines that the condition for closing the vent valve 8 is satisfied when the magnitude of the load on the gas engine 1 indicated by the load signal acquired by the signal acquisition unit 11 is constant after the rapid decrease.
(3) The excessively increased rotation speed decreases. The control unit 12 determines that the condition for closing the vent valve 8 is satisfied when the rotation speed of the engine 9 indicated by the rotation speed signal acquired by the signal acquisition unit 11 increases excessively and starts to decrease after a rapid decrease in the load. FIG. 3 shows an example of the rotation speed of the engine 9 when the load is rapidly decreased. As shown in the drawing, when the load rapidly decreases at time T1 and the fuel control valve 5 is throttled, the rotation speed of the engine 9 temporarily increases excessively. When the excessively increased rotation speed starts to decrease, the control unit 12 determines that the condition for closing the vent valve 8 is satisfied.
(4) A predetermined time elapses. The control unit 12 determines that the condition for closing the vent valve 8 is satisfied when a predetermined time elapses after the signal acquisition unit 11 acquires the rapid load decrease signal.

The control unit 12 determines whether the condition for closing the vent valve 8 is satisfied, based on any one of the conditions (1) to (4) above. The user may arbitrarily set which of the conditions (1) to (4) is used for determination. When the condition is satisfied (step S3: Yes), the control unit 12 closes the vent valve 8 (step S4).

When the condition is not satisfied (step S3: No), the control unit 12 repeatedly performs the determination in step S3.

Next, the control unit 12 determines whether the opening and closing control of the vent valve 8 is to be ended (step S5). For example, when a stop instruction for the gas engine 1 is input by the user, the control unit 12 determines that the opening and closing control is to be ended (step S5: Yes), and ends the processing in the flowchart of FIG. 2. When the opening and closing control is not ended (step S5: No), the process from step S1 is repeatedly executed.

### Effects

FIG. 3 shows an example of behavior of the engine rotation speed in a case where the opening and closing control of the vent valve 8 of the present embodiment is applied and a case where the opening and closing control is not applied, at the time of a rapid decrease in load. The vertical axis of FIG. 3 indicates the rotation speed, and the horizontal axis indicates time. Graphs 31 and 32 show the transition of the engine rotation speed in the control in the related art, and graph 33 shows the transition of the engine rotation speed in a case where the opening and closing control of the vent valve 8 is applied. In any case, a load decrease occurs at time T1. Referring to the graph 31 under the control in the related art, the rotation speed after the rapid decrease in the load increases excessively and exceeds the threshold value Th1. In Graph 32, the rotation speed after the rapid decrease in the load also increases to a level approaching the threshold value Th1. As described above, in the related art, there is no margin at all with respect to the threshold value Th1, and in some cases, the threshold value Th1 may be exceeded. In contrast, when referring to the graph 33 according to the present embodiment, it can be seen that the excessive increase in the rotation speed after the load rapidly decreases is suppressed to a lower level than in the graphs 31 and 32.

As described above, according to the present embodiment, the exhaust line 7 and the vent valve 8 for discharging the fuel gas to the vicinity of the engine 9 on the downstream side of the fuel control valve 5 are provided, in contrast to the related art, in which all of the fuel gas that has passed through the fuel control valve 5 is introduced into the engine 9. Then, when the load on the gas engine 1 is rapidly decreased, the fuel control valve 5 is instantaneously throttled, and the vent valve 8 is opened to discharge the surplus fuel gas remaining in the pipe on the downstream side of the fuel control valve 5 and to prevent the surplus fuel gas from flowing into the engine 9. Accordingly, in the related art, when the load of the gas engine is rapidly decreased, the rotation speed increases excessively and overshoots due to the surplus fuel. In contrast, the excessive increase in the rotation speed can be suppressed (FIG. 3).

From the viewpoints of safety and fuel consumption, the discharged fuel gas is not released to the atmosphere and a pipe structure is provided to return the fuel gas to the intake air system (for example, the air cleaner box 3) of the engine 9. In this manner, the safety can be ensured without releasing the combustible material around the generator, and the combustible material can be reused as the fuel of the engine 9. Therefore, the fuel consumption can be improved.

### Other Configuration Example

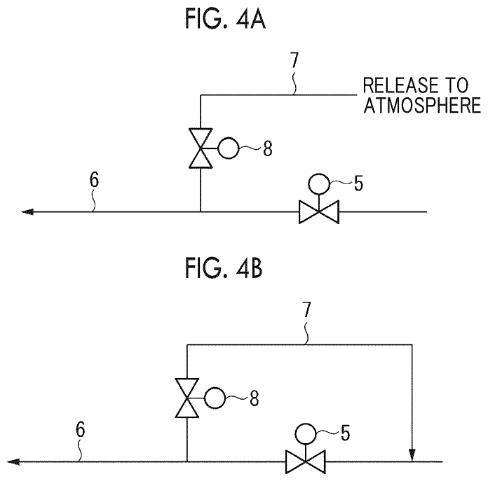

In the configuration example of FIG. 1, the other end of the exhaust line 7 is connected to the air cleaner box 3. However, the other end of the exhaust line 7 may be connected to another position of the air supply line 4 without being limited to the air cleaner box 3. The other end of the exhaust line 7 may be configured to release the fuel gas to the atmosphere or to circulate the fuel gas to the fuel supply line 6 instead of being connected to the air supply line 4. FIGS. 4A and 4B show another configuration example of the exhaust line 7. As shown in FIG. 4A, the other end of the exhaust line 7 may not be connected to anywhere, and the fuel gas may be released to the atmosphere. In this case, the fuel gas is guided to a safe position by the exhaust line 7 and released to the atmosphere so that the combustible material is not released around the generator. As shown in FIG. 4B, the other end of the exhaust line 7 may be connected to the fuel supply line 6, and the fuel gas may be returned to the fuel supply line 6. For example, the fuel supply line 6 may be connected to the upstream side of the fuel control valve 5. In this manner, safety can be ensured, and fuel consumption can be improved. The other end of the exhaust line 7 may be switchable between connection to the air supply line 4, connection to the fuel supply line 6, and a state in which the other end of the exhaust line 7 is not connected to either the air supply line 4 or the fuel supply line 6.

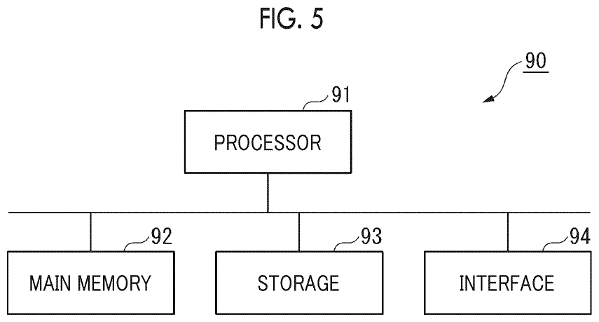

FIG. 5 is a schematic block diagram showing a hardware configuration of the control device according to the embodiment. A computer 90 includes a processor 91, a main memory 92, a storage 93, and an interface 94. The above-described control device 10 is implemented in the computer 90. The operation of each processing unit described above is stored in the storage 93 in the form of a program. The processor 91 reads the program from the storage 93, develops the program in the main memory 92, and executes the above-described processing according to the program. The processor 91 secures a storage area corresponding to each storage unit described above in the main memory 92 according to the program. Examples of the processor 91 include a central processing unit (CPU), a graphics processing unit (GPU), and a microprocessor.

The program may be for realizing some of the functions to be exhibited by the computer 90. For example, the program may exhibit a function in combination with another program already stored in a storage or in combination with another program implemented in another device. In another embodiment, the computer 90 may include a custom large scale integrated circuit (LSI) such as a programmable logic device (PLD) in addition to or instead of the above configuration. Examples of the PLDs include a programmable array logic (PAL), a generic array logic (GAL), a complex programmable logic device (CPLD), and a field programmable gate array (FPGA). In this case, some or all of the functions realized by the processor 91 may be realized by the integrated circuit. Such an integrated circuit is also included in an example of the processor.

Examples of the storage 93 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The storage 93 may be an internal medium directly connected to a bus of the computer 90, or may be an external medium connected to the computer 90 via the interface 94 or a communication line. When this program is distributed to the computer 90 via the communication line, the computer 90 that has received the distribution may develop the program in the main memory 92, and may execute the above-described processing. In at least one embodiment, the storage 93 is a non-transitory tangible storage medium.

The program may realize a part of the foregoing functions. Further, the program may be a program that realizes the functions described above in combination with other programs already stored in the storage 93, that is, a so-called difference file (difference program).

While some embodiments of the present disclosure have been described above, these embodiments have been presented by way of example only, and are not intended to limit the scope of the invention. These embodiments can be implemented in various other forms, and various omissions, replacements, and changes can be made without departing from the gist of the invention. These embodiments and modifications thereof are included in the scope of the invention described in the claims and the equivalent scope thereof, as well as in the scope and gist of the invention.

### Additional Notes

The control device, the gas engine, the control method, and the program described in each embodiment are understood as follows, for example.
(1) A control device according to a first aspect is a control device for a vent valve provided in an exhaust line that is connected to a downstream side of a fuel control valve in a fuel supply line that supplies a fuel to a gas engine, and guides the fuel to an outside of the fuel supply line, the control device including a signal acquisition unit that acquires a signal indicating a rapid decrease in a load of the gas engine, and a control unit that opens the vent valve when the signal is acquired.

In this manner, it is possible to suppress an excessive increase in the rotation speed due to the surplus fuel when the load on the gas engine is rapidly decreased.
(2) The control device according to a second aspect is the control device of (1), in which the control unit closes the vent valve when the load is stable after the vent valve is opened.

In this manner, the vent valve is opened and closed as necessary, and the fuel gas is not unnecessarily released.
(3) The control device according to a third aspect is the control device of (1) to (2), in which the control unit closes the vent valve when an increase in a rotation speed of the gas engine turns to a decrease after the vent valve is opened.

In this manner, the vent valve is opened and closed as necessary, and the fuel gas is not unnecessarily released.
(4) A gas engine according to a fourth aspect includes a fuel supply line that supplies a fuel to the gas engine, a fuel control valve provided in the fuel supply line, an exhaust line having one end connected to a downstream side of the fuel control valve in the fuel supply line and that guides the fuel to an outside of the fuel supply line, a vent valve provided in the exhaust line, and the control device according to any one of (1) to (3).

In this manner, the fuel gas present in the fuel supply line on the downstream side of the fuel control valve can be discharged at the time of the rapid decrease in the load, and it is possible to avoid an excessive increase in the engine rotation speed and a trip as a result thereof.
(5) The gas engine according to a fifth aspect is the gas engine of (4), further including an air supply line that supplies air to the gas engine, in which the other end of the exhaust line is connected to the air supply line.

In this manner, the fuel gas present in the fuel supply line on the downstream side of the fuel control valve can be discharged when the load rapidly decreases. Safety can be ensured and fuel consumption can be reduced.
(6) The gas engine according to a sixth aspect is the gas engine of (4), in which the other end of the exhaust line is connected to an upstream side of the fuel control valve in the fuel supply line (FIG. 4B).

In this manner, the fuel gas present in the fuel supply line on the downstream side of the fuel control valve can be discharged when the load rapidly decreases. Safety can be ensured and fuel consumption can be reduced.
(7) The gas engine according to a seventh aspect is the gas engine of (4), in which the other end of the exhaust line is not connected (FIG. 4A).

In this manner, the fuel gas present in the fuel supply line on the downstream side of the fuel control valve can be discharged when the load rapidly decreases.
(8) The gas engine according to an eighth aspect is the gas engine of (4) to (7), in which one end of the exhaust line is connected to the fuel supply line at a position where a distance to the gas engine from a position to which the one end is connected is shorter than a distance to the fuel control valve from a position to which the one end is connected.

In this manner, the fuel gas present on the downstream side of the fuel control valve of the fuel supply line can be effectively released when the load rapidly decreases.
(9) A control method according to a ninth aspect is a control method for a vent valve provided in an exhaust line that is connected to a downstream side of a fuel control valve in a fuel supply line that supplies a fuel to a gas engine, and guides the fuel to an outside of the fuel supply line, the control method including a step of acquiring a signal indicating a rapid decrease in a load of the gas engine, and a step of opening the vent valve when the signal is acquired.
(10) A program according to a tenth aspect is a program causing a computer to execute a step of acquiring a signal indicating a rapid decrease in a load of a gas engine, and a step of opening a vent valve provided in an exhaust line that is connected to a downstream side of a fuel control valve in a fuel supply line that supplies a fuel to a gas engine, and guides the fuel to an outside of the fuel supply line, when the signal is acquired.

### INDUSTRIAL APPLICABILITY

According to the control device, the gas engine, the control method, and the program described above, it is possible to suppress an excessive increase in the rotation speed of the engine when the load on the gas engine is rapidly decreased.

### REFERENCE SIGNS LIST

1: gas engine
2: air cleaner
3: air cleaner box
4: air supply line
5: fuel control valve
6: fuel supply line
7: exhaust line
8: vent valve
9: engine
10: control device
11: signal acquisition unit
12: control unit
31, 32, 33: graph
90: computer
91: processor
92: main memory
93: storage
94: interface

1. A control device for a vent valve provided in an exhaust line that is connected to a downstream side of a fuel control valve in a fuel supply line that supplies a fuel to a gas engine, and guides the fuel to an outside of the fuel supply line, the control device comprising:
a signal acquisition unit that acquires a signal indicating a rapid decrease in a load of the gas engine; and
a control unit that opens the vent valve when the signal is acquired.

2. The control device according to claim 1,
wherein the control unit closes the vent valve when the load is stable after the vent valve is opened.

3. The control device according to claim 1,
wherein the control unit closes the vent valve when a temporary increase in a rotation speed of the gas engine turns to a decrease after the vent valve is opened.

4. A gas engine comprising:
a fuel supply line that supplies a fuel to the gas engine;
a fuel control valve provided in the fuel supply line;
an exhaust line having one end connected to a downstream side of the fuel control valve in the fuel supply line;
a vent valve provided in the exhaust line; and
the control device according to claim 1.

5. The gas engine according to claim 4, further comprising:
an air supply line that supplies air to the gas engine,
wherein the other end of the exhaust line is connected to the air supply line.

6. The gas engine according to claim 4,
wherein the other end of the exhaust line is connected to an upstream side of the fuel control valve in the fuel supply line.

7. The gas engine according to claim 4,
wherein the other end of the exhaust line is not connected.

8. The gas engine according to claim 4,
wherein one end of the exhaust line is connected to the fuel supply line at a position where a distance to the gas engine from a position to which the one end is connected is shorter than a distance to the fuel control valve from a position to which the one end is connected.

9. A control method for a vent valve provided in an exhaust line that is connected to a downstream side of a fuel control valve in a fuel supply line that supplies a fuel to a gas engine, and guides the fuel to an outside of the fuel supply line, the control method comprising:
a step of acquiring a signal indicating a rapid decrease in a load of the gas engine; and
a step of opening the vent valve when the signal is acquired.

10. A program causing a computer to execute:
a step of acquiring a signal indicating a rapid decrease in a load of a gas engine; and
a step of opening a vent valve provided in an exhaust line that is connected to a downstream side of a fuel control valve in a fuel supply line that supplies a fuel to a gas engine, and guides the fuel to an outside of the fuel supply line, when the signal is acquired.

11. A gas engine comprising:
a fuel supply line that supplies a fuel to the gas engine;
a fuel control valve provided in the fuel supply line;
an exhaust line having one end connected to a downstream side of the fuel control valve in the fuel supply line;
a vent valve provided in the exhaust line; and
the control device according to claim 2.

12. A gas engine comprising:
a fuel supply line that supplies a fuel to the gas engine;
a fuel control valve provided in the fuel supply line;
an exhaust line having one end connected to a downstream side of the fuel control valve in the fuel supply line;
a vent valve provided in the exhaust line; and
the control device according to claim 3.
